(19) United States
(12) Patent Application Publication
(10) Pub. No.: US 2015/0055814 A1
(43) Pub. Date: Feb. 26, 2015

(54) HEADPHONE FOR REPRODUCING SOUND STAGE EFFECT

(71) Applicant: Mao-Liang Liu, Taipei City (TW)

(72) Inventor: Mao-Liang Liu, Taipei City (TW)

(21) Appl. No.: 14/195,772

(22) Filed: Mar. 3, 2014

(30) Foreign Application Priority Data
Aug. 20, 2013 (TW) 102215714

(51) Int. Cl. H04R 1/10

(52) U.S. Cl. CPC H04R 1/1066
USPC 381/373

(57) ABSTRACT

A headphone for reproducing sound stage effect comprises of a housing including outer surface covering the ear, an inner wall corresponding to the combination of the outer surface, and a hollow chamber arranged inside the housing, a sound guiding hole is disposed in the center of the inner wall guiding the sound output; a padding, one side is combined with an outside of the inner wall, the other is for contacting with human face and a pinhole is arranged in the center corresponding to the sound guiding hole; a speaker baffle is arranged at one side of the chamber of the housing provided with an open hole, which the front is faced with the other side and integrated tightly with the outer surface and the inner wall without covering the sound guiding hole, and which is set close to the vertical with the inner wall to form a small space for accommodating a speaker; the speaker is disposed behind the baffle, which sounds export to the chamber by the open hole of the baffle.

### FIELD OF THE INVENTION

The utility model relates to a headphone, in particular to a headphone for reproducing sound stage effect.

### BACKGROUND OF THE INVENTION

No matter what the earbud or the circumaural type, direction of the sound from traditional headphones are directly toward the ear canal of two sides of the face. These types of headphones cannot distinguish direction of the sound perpendicular to the front and back face, and overall sound stage, contrary to the ears can distinguish that the sound propagation direction, range, panning and the different time of the sound arrival in the natural environment. Therefore, unlike floor speakers, the traditional headphones cannot perform stage sound or music. FIG. 1 is schematic top view of the traditional headphone putting on the human head; right ear (11) and left ear is (12) in the human head (1) are respectively covered with a right housing (21) and a left housing (22), which inside are provided respectively with a speaker (24) arranged on a baffle (25), and a headband (23) between them, a earpad (26) is respectively disposed inside the housing (21), (22) to make skin more comfortable, wherein two speakers (24) are arranged in parallel on the human ears (11), (12), which mean direction of the sound is toward the right or left side of ear (11), (12) that cannot gather the sound from the front or block the back as a function of the sound source identification. Thus the applicant is engaged in research and development for providing actual demand item.

### SUMMARY OF INVENTION

The purpose of the utility model is to provide a headphone for reproducing sound stage effect, redesigning the location of the speaker for listening to the sound like floor speaks and rebuilding the stage of natural sound; the location and the direction of the headphone speaker is set close to the vertical with human face. And adjust the inclination Toe-In or Toe-Out camber angle, when listening to the music, the sound like floor speakers after the design is completed.

A headphone for reproducing sound stage effect comprises of

a housing (3) including outer surface (32) covering the ear, an inner wall (33) corresponding to the combination of the outer surface (32), and a hollow chamber (31) arranged inside the housing (3), a sound guiding hole (35) is disposed in the center of the inner wall (33) guiding the sound output;

a padding (4), one side is combined with an outside of the inner wall (33), the other is for contacting with human face and a pinhole (41) is arranged in the center corresponding to the sound guiding hole (35);

a speaker baffle (5) is arranged at one side of the chamber (31) of the housing (3) provided with an open hole (51), which the front is faced with the other side and integrated tightly with the outer surface (32) and the inner wall (33) without covering the sound guiding hole (35), and which is set close to the vertical with the inner wall (33) to form a small space (34) for accommodating a speaker (6);

the speaker (6) is disposed behind the baffle (5), which sounds export to the chamber (31) by the open hole (51) of the baffle (5).

### BRIEF DESCRIPTION OF THE DRAWINGS

FIG. 1 is schematic top view of the traditional headphone putting on the human head.

FIG. 2 is a schematic view of a headphone for reproducing sound stage effect of the first embodiment.

FIG. 3 is a schematic view of a headphone for reproducing sound stage effect of the second embodiment.

FIG. 4 is a schematic view of a headphone for reproducing sound stage effect of the second embodiment.

FIG. 5 is a schematic view showing the baffle at an inclination angle of a headphone for reproducing sound stage effect.

FIG. 6 is a schematic view showing the baffle at a camber angle of a headphone for reproducing sound stage effect.

FIG. 7 is a schematic view showing a plurality of first pinholes with ventilation function of a headphone for reproducing sound stage effect.

FIG. 8 is a schematic view showing a plurality of second pinholes of a headphone for reproducing sound stage effect.

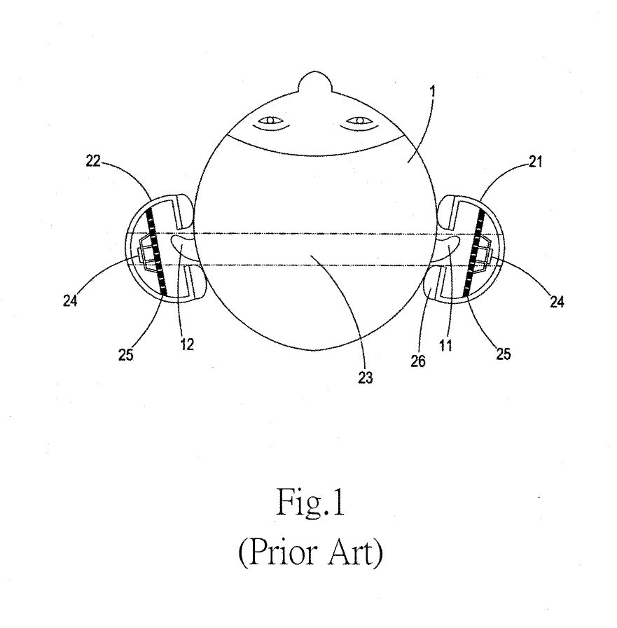

### DETAILED DESCRIPTION OF THE PREFERRED EMBODIMENTS

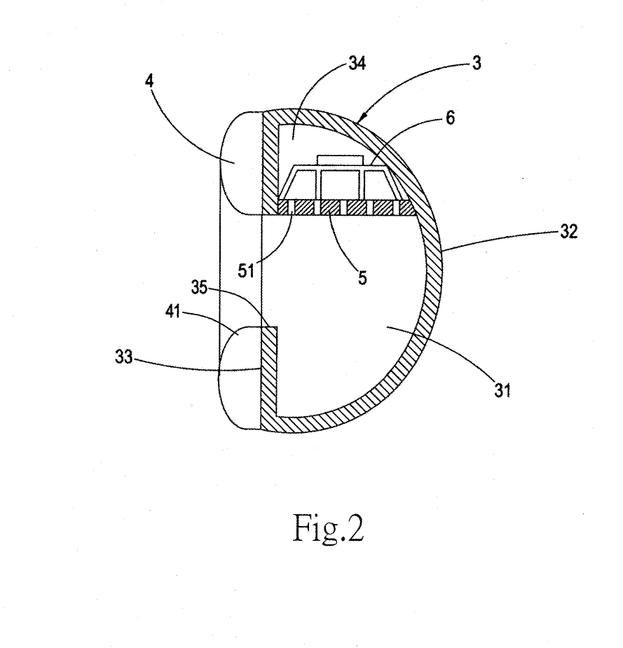

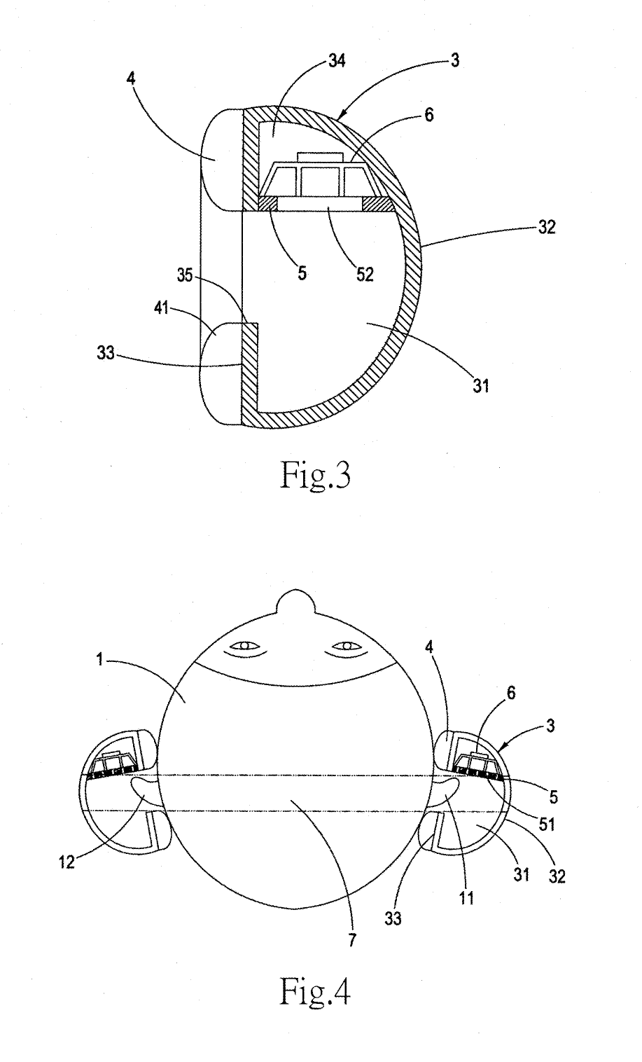

Referring to FIG. 2, a headphone for reproducing sound stage effect comprises of a housing (3) including outer surface (32) covering the ear, an inner wall (33) corresponding to the combination of the outer surface (32), and a hollow chamber (31) arranged inside the housing (3), a sound guiding hole (35) is disposed in the center of the inner wall (33) guiding the sound output; a padding (4), one side is combined with an outside of the inner wall (33), the other is for contacting with human face and a pinhole (41) is arranged in the center corresponding to the sound guiding hole (35); a speaker baffle (5) is arranged at one side of the chamber (31) of the housing (3) provided with an open hole (51), which the front is faced with the other side and integrated tightly with the outer surface (32) and the inner wall (33) without covering the sound guiding hole (35), and which is set close to the vertical with the inner wall (33) to form a small space (34) for accommodating a speaker (6); the speaker (6) is disposed behind the baffle (5), which sounds export to the chamber (31) by the open hole (51) of the baffle (5). When the human head (1) are putting on the headphone as referring to FIG. 4, the ears (11), (12) will be covered by the chamber (31) of the housing (3) and being close to the vertical with the baffle (5), which can be reproduced sound stage effect by accepting sounds from the front side.

Moreover, the baffle (5) can be provided with a bigger diameter open hold (52) as shown in FIG. 3, which also be the same sound stage effect. Therefore this is not coupled to repeat.

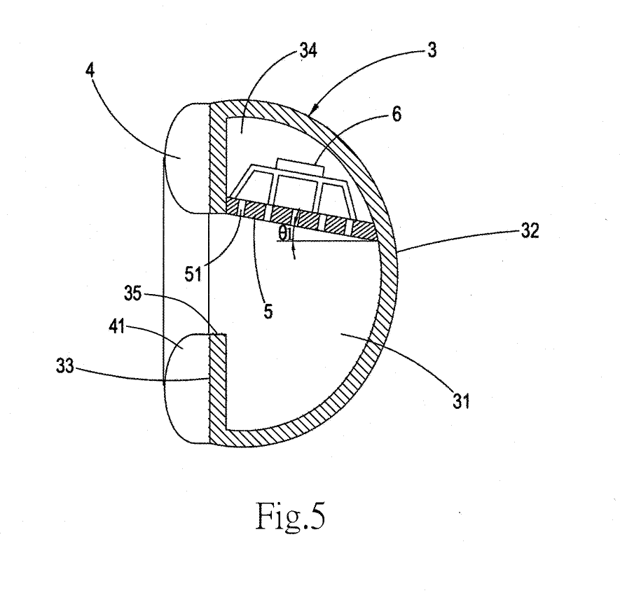

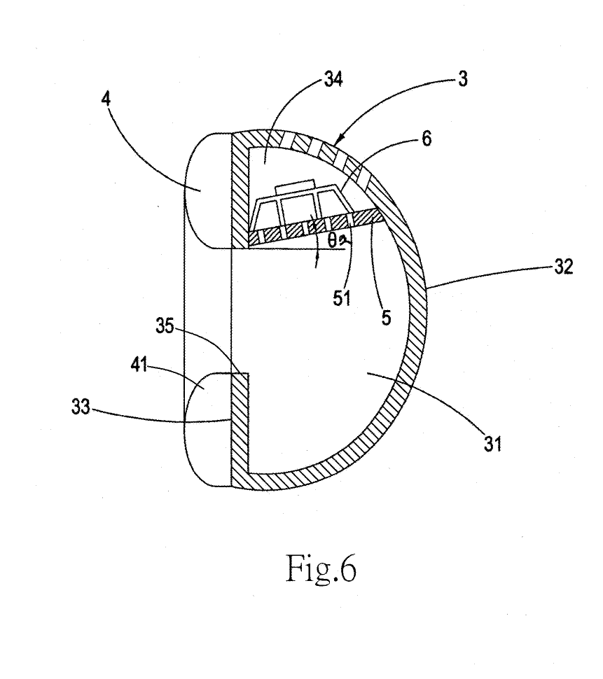

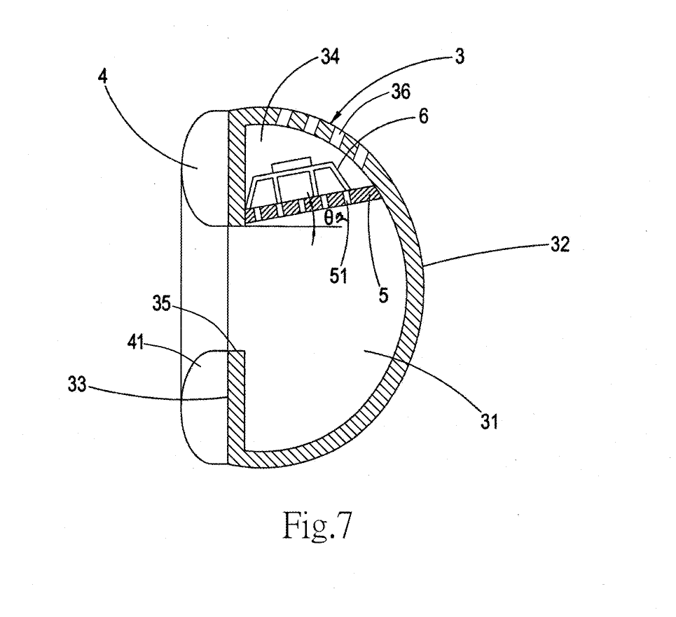

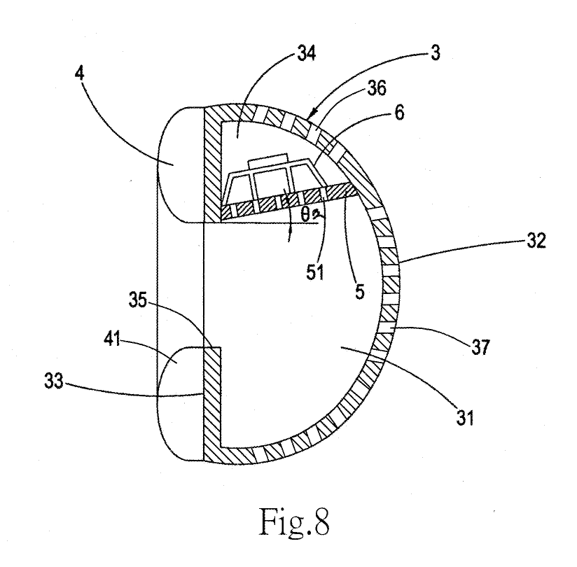

The utility model can be an earbud or a circumaural type headphone depending on demand, if it is an earbud type, the housing (3) is provided with an ear hook (not shown in figures). If it is a circumaural type as shown in FIG. 4, the housing is provided with a headband (7) between a right ear house and a left ear housing, which covered respectively the right (11) and left ear (12), the structures of which are the same as the housing (3) shown in FIG. 2, not described in detail.

Wherein the baffle can be arranged inside the chamber (3) at an inclination angle θ1 as shown in FIG. 5 or a camber angle θ2 as shown in FIG. 6 depending on demand.

Besides, the speaker (6) of the above mentioned embodiments can be a traditional speaker, electrostatic speak, piezoelectric crystals, magnetic reed sound transducers, etc., wherein the means of energy conversion.

In summary, the utility model is used for changing the position of speak, the direction of the sound is close to the vertical with the ears (11), (12) in proper distance, so that the brain can distinguish between the front and rear direction, volume, and other sources of phase lag effect, like the performance of the floor speaker sound field which are able to provide good usability and completely different from the prior art.

The above embodiment is only the creation of preferred embodiments and are not intended to limit the creation, where any modifications within the spirit and principles of the creation made, equivalent replacement, improvement, etc., should contain within the scope of protection of the creation.

I claim:

1. A headphone for reproducing sound stage effect, characterized by comprising:
a housing (3) includes outer surface (32) covering the ear, an inner wall (33) corresponding to the combination of the outer surface (32), and a hollow chamber (31) arranged inside the housing (3), a sound guiding hole (35) is disposed in the center of the inner wall (33) guiding the sound output;
a padding (4), one side is combined with an outside of the inner wall (33), the other is for contacting with human face and a pinhole (41) is arranged in the center corresponding to the sound guiding hole (35);
a speaker baffle (5) is arranged at one side of the chamber (31) of the housing (3) provided with an open hole (51), which the front is faced with the other side and integrated tightly with the outer surface (32) and the inner wall (33) without covering the sound guiding hole (35), and which is set close to the vertical with the inner wall (33) to form a small space (34) for accommodating a speaker (6);
the speaker (6) is disposed behind the baffle (5), which sounds export to the chamber (31) by the open hole (51) of the baffle (5);

2. The headphone for reproducing sound stage effect in claim 1, the housing (3) is provided with an ear hook (not disclosed).

3. The headphone for reproducing sound stage effect in claim 1, the housing is provided with a headband (7) between a right ear house and a left ear housing.

4. The headphone for reproducing sound stage effect in claim 1, the baffle (5) is provided with a plurality of the open holes (51).

5. The headphone for reproducing sound stage effect in claim 1, the baffle (5) is provided with a bigger diameter open hold (52).

6. The headphone for reproducing sound stage effect in claim 1, the baffle (5) is arranged inside the chamber (3) at an inclination angle θ1.

7. The headphone for reproducing sound stage effect in claim 1, the baffle (5) is arranged inside the chamber (3) at a camber angle θ2.

8. The headphone for reproducing sound stage effect in claim 1, the outer surface (32) of the space (34) is provided with a plurality of first pinholes (36) with ventilation function.

9. The headphone for reproducing sound stage effect in claim 1, the outer surface (32) of the space (34) is provided with a plurality of second pinholes (37) which can change the thickness of audio.
